(19) United States
(12) Patent Application Publication
(10) Pub. No.: US 2018/0001709 A1
(43) Pub. Date: Jan. 4, 2018

(54) PNEUMATIC TIRE

(71) Applicant: Toyo Tire & Rubber Co., Ltd., Osaka (JP)

(72) Inventor: Tsuyoshi Fujioka, Osaka-shi (JP)

(73) Assignee: Toyo Tire & Rubber Co., Ltd., Osaka (JP)

(21) Appl. No.: 15/615,975

(22) Filed: Jun. 7, 2017

(30) Foreign Application Priority Data
Jun. 30, 2016 (JP) 2016-130543

(51) Int. Cl. B60C 11/04; B60C 11/03; B60C 11/13

(52) U.S. Cl. CPC B60C 11/047; B60C 2011/1361; B60C 2011/0341; B60C 2011/0358

(57) ABSTRACT

In a pneumatic tire having main grooves extending in a tire circumferential direction and land portions partitioned by the main grooves in a tread portion, a plurality of protrusions are disposed at a groove bottom of the main groove at intervals in a groove length direction, and a side surface portion of the protrusion is connected to a side surface portion of the land portion via a connecting portion having a height equal to or less than a height of the protrusion and a width narrower than a width of the protrusion.

### CROSS-REFERENCE TO RELATED APPLICATIONS

This application is based upon and claims the benefit of priority from the prior Japanese Patent Application No. 2016-130543, filed on Jun. 30, 2016; the entire contents of which are incorporated herein by reference.

### BACKGROUND

### 1. Field of the Invention

This embodiment relates to a pneumatic tire.

### 2. Related Art

In general, a tread portion of a pneumatic tire is provided with main grooves extending in a tire circumferential direction. In the related art, in order to prevent a stone from entering into a groove and being trapped therein, protrusions for preventing stone biting or trapping may be provided at a groove bottom of the main groove.

For example, U.S. Pat. No. 6,176,284 B1 discloses a configuration in which protrusions for preventing stone biting is provided so as to surround a block in a ring shape, and the protrusions are divided into main protrusion portions and narrow sub-protrusion portions connecting the main protrusion portions in order to enhance an effect of suppressing stone biting. JP-A-2002-211210 discloses a configuration in which protrusions having different heights are disposed in a pattern repeating irregularities at a groove bottom of a main groove in order to reduce noise while preventing stone biting. However, it is not disclosed that the protrusions are connected to a groove wall surface of the main groove.

On the other hand, JP-A-2007-210569 discloses a configuration in which protrusions are provided at a groove bottom of a main groove, and protruding pieces for reducing air-columnar resonance are protruded from the groove wall surface of the main groove so as to extend to the protrusions of the groove bottom. The protruding pieces are provided so as to connect the protrusions and the groove wall surfaces of the main grooves, but are provided over substantially an entire depth of the main groove in order to reduce air-columnar resonance sound. Therefore, a flow path of the main groove is largely blocked by the protruding pieces and the drainability of the main groove decreases thereby causing a loss of a wet property that is a running performance on a wet road surface.

In addition, JP-A-2003-054220 discloses a configuration in which a side wall surface of a protrusion and a side wall surface of a block are connected by a connecting portion in order to increase the rigidity of the protrusion provided at a groove bottom of a main groove. A height of the connecting portion is set not to exceed a height of the protrusion, but a width of the connecting portion is not taken into consideration.

In a case where the protrusions for preventing stone biting are provided in the groove bottom of the main groove, it is required to suppress chipping of the protrusions due to the stone. In addition, the provision of protrusions may cause reduction in a traction property at an end of tire wear, and improvement is required. In addition, in a case where the protrusion at the groove bottom is connected to the groove wall surface of the main groove, it is also required to suppress the deterioration of a wet property by the connecting portion.

### SUMMARY

An object of this embodiment is to ensure a wet property or a traction property at an end of wear while suppressing chipping of protrusions by stones.

According to the embodiment, there is provided a pneumatic tire having a tread portion including a main groove extending in a tire circumferential direction and a land portion partitioned by the main groove, in which a plurality of protrusions are disposed at a groove bottom of the main groove at intervals in a groove length direction, and a side surface portion of at least one protrusions is connected to a side surface portion of the land portion via a connecting portion having a height equal to or less than a height of the protrusion and a width narrower than a width of the protrusion.

### BRIEF DESCRIPTION OF THE DRAWINGS

FIG. 1 is a perspective view of a pneumatic tire according to an embodiment.

FIG. 2 is partially enlarged perspective view of a tread portion of the same embodiment.

FIG. 3 is a developed view illustrating a tread pattern of the same embodiment.

FIG. 4 is an enlarged plan view of a main portion of the tread portion of the same embodiment.

FIG. 5 is an enlarged plan view illustrating a protrusion of the same embodiment.

FIG. 6 is a sectional view that is taken along line VI-VI of FIG. 4.

FIG. 7 is a sectional view that is taken along line VII-VII of FIG. 6.

### DETAILED DESCRIPTION

Hereinafter, embodiments will be described with reference to the drawings.

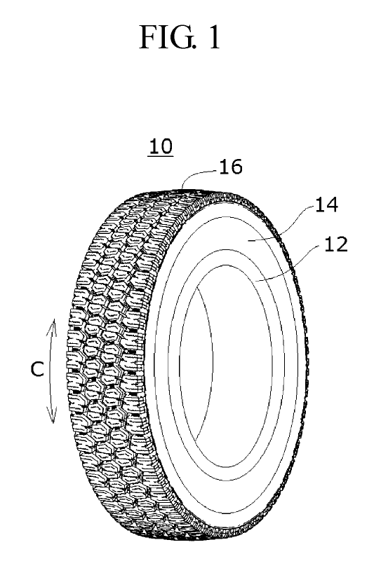

As illustrated in FIG. 1, a pneumatic tire 10 according to an embodiment includes a pair of right and left bead portions 12 and side wall portions 14, and a tread portion 16 that is provided between both side wall portions so as to connect radially outer end portions of the right and left side wall portions 14, and a general tire structure can be adopted for other than a tread pattern.

As illustrated in FIGS. 1 to 3, a plurality of block rows 22 formed by a plurality of main grooves 18 extending in a tire circumferential direction C and a plurality of lateral grooves 20 intersecting the main grooves 18 are provided on a tread rubber surface of the tread portion 16 in a tire width direction W.

In the example, three main grooves 18 are formed at intervals in the tire width direction W. A center main groove 18A positioned on a tire equator CL and a pair of shoulder main grooves 18B and 18B disposed on both sides are provided. Each of the three main grooves 18 is a zigzag groove extending in the tire circumferential direction C while being bent. Moreover, the main groove 18 is a circumferential groove having a groove width (opening width) of generally 5 mm or more.

A plurality of land portions partitioned by the main grooves 18 are formed in the tread portion 16. The plurality of lateral grooves 20 are provided at intervals in the tire circumferential direction C. Therefore, each land portion is formed as the block row 22 formed by disposing a plurality of blocks in the tire circumferential direction C. More specifically, a pair of right and left center land portions sandwiched between the center main groove 18A and the shoulder main grooves 18B is formed as center block rows 22A formed by disposing a plurality of center blocks 24 in the tire circumferential direction C by providing lateral grooves 20A. The center block row 22A is a block row positioned at a center portion in the tire width direction W in the tread portion 16. In addition, a pair of right and left shoulder land portions sandwiched between the shoulder main grooves 18B and tire ground contact ends E is formed as shoulder block rows 22B formed by disposing a plurality of shoulder blocks 26 in the tire circumferential direction C by providing the lateral grooves 20B. The shoulder block rows 22B are block rows positioned at both end portions in the tire width direction in the tread portion 16.

The lateral grooves 20A and 20B are grooves extending in a direction intersecting main grooves 18A and 18B, and crossing each land portion. The lateral grooves 20A and 20B may not necessarily be parallel to the tire width direction W as long as they are grooves extending in the tire width direction W. In the example, the lateral grooves 20A and 20B are grooves extending in the tire width direction W while being inclined.

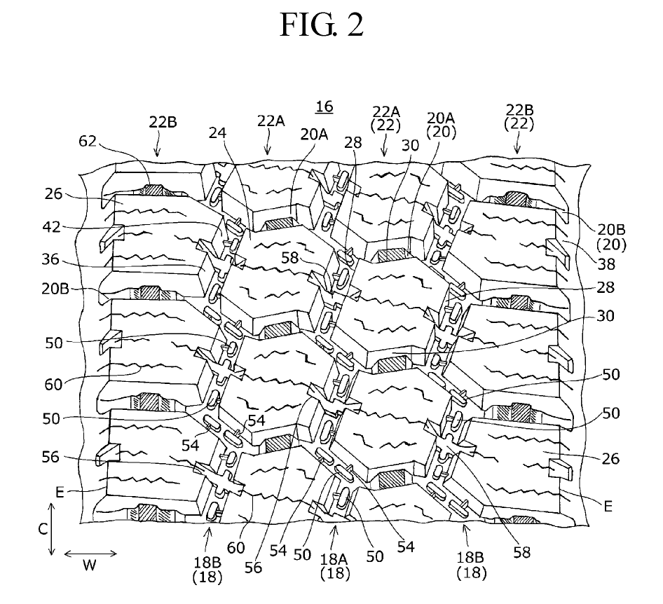

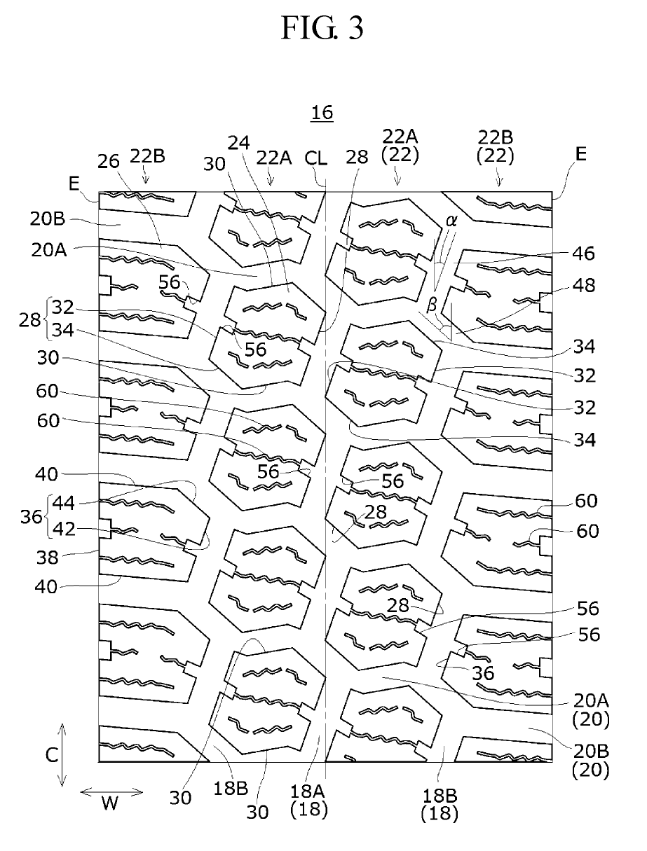

As illustrated in FIGS. 2 and 3, the center block 24 includes a pair of right and left longitudinal side surface portions 28 and 28 facing the right and left main grooves 18A and 18B, and a pair of front and rear lateral side surface portions 30 and 30 facing the front and rear lateral grooves 20A and 20A. Here, the longitudinal side surface portion 28 is a side surface portion facing the main groove 18 (that is, configuring a part of a groove wall surface of the main groove by being in contact with the main groove) out of side surface portions of the block 24. The lateral side surface portion 30 is a side surface portion facing the lateral groove 20 (that is, configuring a part of a groove wall surface of the lateral groove by being in contact with the lateral groove) out of the side surface portions of the block 24.

In the example, the center block 24 has a substantially hexagonal shape (convex hexagonal shape) in a plan view. Specifically, the pair of longitudinal side surface portions 28 and 28 are formed of a pair of first longitudinal side surface portions 32 and 32 which is inclined with respect to the tire circumferential direction C and is parallel to each other, and a pair of second longitudinal side surface portions 34 and 34 which is shorter than the first longitudinal side surface portions 32 in length, is inclined greater with respect to the tire circumferential direction C than the first longitudinal side surface portions 32, and is parallel to each other. The second longitudinal side surface portion 34 is formed to intersect with the first longitudinal side surface portion 32 at an obtuse angle. In addition, the pair of lateral side surface portions 30 and 30 is side surface portions inclined with respect to the tire width direction W and parallel to each other. The lateral side surface portion 30 is interposed between the first longitudinal side surface portion 32 of one longitudinal side surface portion 28 and the second longitudinal side surface portion 34 of the other longitudinal side surface portion 28 to connect them.

The shoulder block 26 has a longitudinal side surface portion 36 facing the shoulder main groove 18B, a longitudinal side surface portion 38 facing the tire ground contact end E (that constitutes a part of a ground contact end wall surface), and a pair of front and rear lateral side surface portions 40 and 40 facing the front and rear lateral grooves 20B and 20B.

In the example, the shoulder block 26 has a substantially pentagonal shape (convex pentagonal shape) in a plan view. Specifically, similarly to the longitudinal side surface portion 28, the longitudinal side surface portion 36 has a third longitudinal side surface portion 42 inclined with respect to the tire circumferential direction C, and a fourth longitudinal side surface portion 44 which is shorter than the third longitudinal side surface portion 42 in length, and inclined greater with respect to the tire circumferential direction C than the third longitudinal side surface portion 42. The fourth longitudinal side surface portion 44 is formed to intersect with the third longitudinal side surface portion 42 at an obtuse angle. Further, the pair of lateral side surface portions 40 and 40 is side surface portions inclined with respect to the tire width direction W and parallel to each other.

Because of the shapes of the center block 24 and the shoulder block 26 described above, the main groove 18 and the lateral groove 20 are provided as follows. As illustrated in FIG. 3, the main groove 18 has a first groove portion 46 that is inclined to one side at the angle α with respect to the tire circumferential direction C and a second groove portion 48 that is inclined to another side at an angle β with respect to the tire circumferential direction C, which are alternately repeated via an obtuse angle bent portion in the tire circumferential direction C thereby forming a zigzag shape. The second groove portion 48 is shorter than the first groove portion 46 and the inclined angle β with respect to the tire circumferential direction C is set greater than the inclined angle α of the first groove portion 46. Moreover, between adjacent main grooves 18A and 18B, top portions of the bent portions are disposed to face each other, the top portions are connected by the lateral groove 20A, and thereby the center block rows 22A are formed. In addition, the lateral grooves 20B are provided outward of the shoulder main groove 18B in the tire width direction from the top portion of each bent portion to the tire ground contact end E and thereby the shoulder block rows 22B are formed.

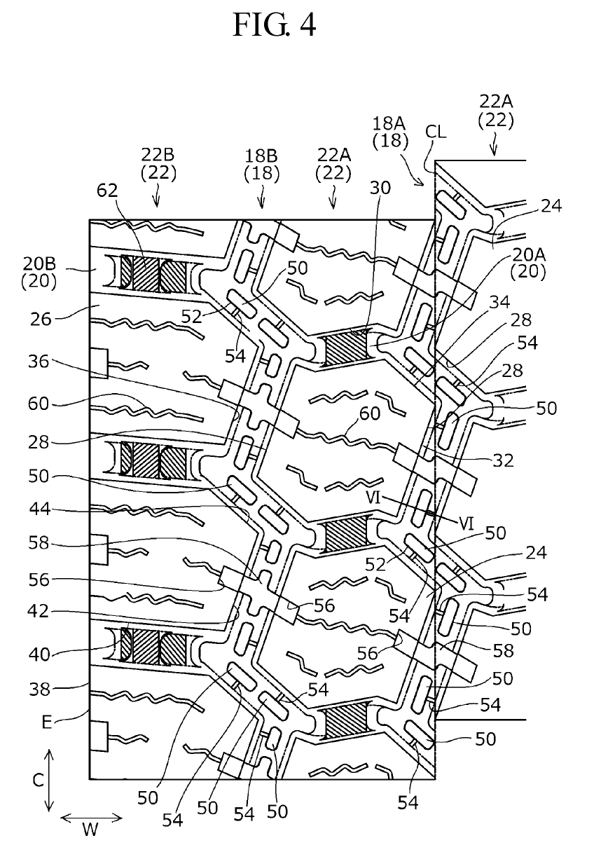

As illustrated in FIGS. 2 and 4, a plurality of protrusions 50 for preventing stone biting or trapping are disposed in the groove bottom of the main groove 18 at intervals in the groove length direction (that is, the length direction of the main groove 18). In the example, the protrusions 50 are provided in an intermittent manner in all groove bottoms of the three main grooves 18A, 18B, and 18B. The protrusion 50 is a protrusion protruding from the groove bottom at the center portion in the width direction of the main groove 18 and is an elongated protrusion extending in the groove length direction, and is provided with gaps with the side surface portions (specifically, the longitudinal side surface portions 28 and 36) of the blocks 24 and 26 which are the land portions on both sides.

A side surface portion 52 of each protrusion 50 is connected to the groove wall surface of the main groove 18 facing each other, that is, the longitudinal side surface portion 28, 36 of the block 24, 26 via the connecting portion 54. One connecting portion 54 is provided for each protrusion 50 and connects the side surface portion 52 of the protrusion 50 and the longitudinal side surface portion 28, 36 of the block 24, 26 facing the side surface portion 52. More specifically, the side surface portion 52 of the protrusion 50 provided in the center main groove 18A is connected to the longitudinal side surface portion 28 of the center block 24 by the connecting portion 54. The side surface portion 52 of the protrusion 50 provided in the shoulder main groove 18B is connected to the longitudinal side surface portion 28 of the center block 24 or the longitudinal side surface portion 36 of the shoulder block 26 by the connecting portion 54.

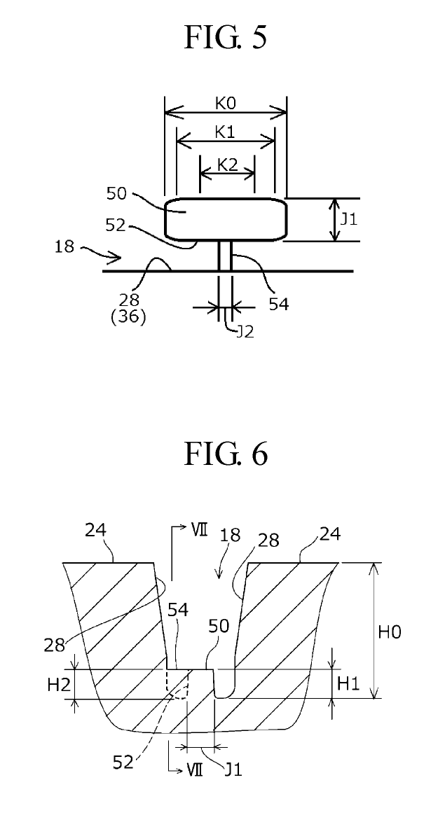

As illustrated in FIGS. 5 to 7, the connecting portion 54 is a plate-shaped portion protruding from the groove bottom so as to close the flow path between the protrusion 50 and the block 24 and 26 facing the protrusion 50. The connecting portion 54 has a height H2 equal to or less than a height H1 of the protrusion 50 and a width J2 narrower than a width J1 of the protrusion 50. Here, the height H1 of the protrusion 50 and the height H2 of the connecting portion 54 are protrusion heights from the groove bottom. The width J1 of the protrusion 50 is a dimension in a direction perpendicular to the groove length direction at the protrusion 50 extending in the groove length direction. The width J2 of the connecting portion 54 is a dimension of the connecting portion 54 in a direction perpendicular to a direction opposite to the protrusion and the land portion.

Although the height H1 of the protrusion 50 is not particularly limited, in the example, it is set to 10 to 40% of a depth H0 of the main groove 18. If it is 10% or more of the main groove depth H0, a stone biting suppression effect can be enhanced. Further, it is possible to suppress the rigidity of the protrusion 50 from deteriorating and suppress chipping of the protrusion 50, if it is 40% or less of the main groove depth H0. In the embodiment, since the protrusion 50 is reinforced by the connecting portion 54, there is an advantage that it is possible to raise the protrusion 50 as compared with the case where it is not connected. In the example, the height of the protrusion 50 is set to be constant between the plurality of protrusions 50.

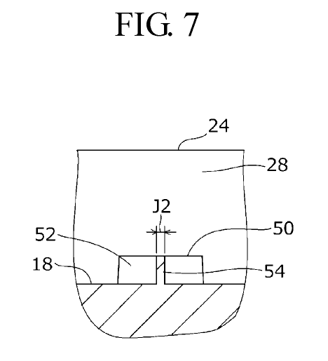

As illustrated in FIG. 7, a cross-sectional shape of the connecting portion 54 may be formed to have a constant width from the top portion to the bottom portion, but the width may be gradually increased from the top portion to the bottom portion. Further, only the bottom portion may be formed divergent by forming the cross-sectional shape of both side portions of the bottom portion (that is, a base portion with respect to the groove bottom) in an arc shape. As described above, it is possible to enhance the rigidity of the connecting portion 54 and suppress chipping by extending the bottom portion of the connecting portion 54.

The connecting portion 54 is provided within a range K1 excluding 5% at both ends in the longitudinal direction length K0 of the protrusion 50 on the side surface portion 52 of the protrusion 50. That is, the connecting portion 54 is provided within the range K1 excluding a range of 5% from the both ends with respect to the longitudinal direction length K0 of the protrusion 50 elongated in the groove length direction. More preferably, the connecting portion 54 is provided within a center region K2 excluding 20% (more preferably 30%) at both ends in the longitudinal direction length K0.

As illustrated in FIG. 4, the connecting portions 54 are alternately provided on the right and left in the groove length direction with respect to the longitudinal side surface portions 28 and 36 of the land portions (blocks 24 and 26) on both sides of the main groove 18. That is, with respect to the protrusions 50 and 50 adjacent to each other along the main groove 18 in the tire circumferential direction C, each connecting portion 54 is provided to connect the longitudinal side surface portions 28 and 36 on the opposite side to each other among the longitudinal side surface portions 28 and 36 of the right and left blocks 24 and 26 facing each other with the main groove 18 interposed therebetween.

As illustrated in FIGS. 2 to 4, recessed notches 56 and 56 are respectively provided on the side surface portions of the blocks 24 and 26 facing each other with the main groove 18 interposed therebetween in order to increase the traction elements and to improve the traction property. The notch 56 is a U-shaped recess in a plan view cut out toward a groove bottom of the main groove 18 from a block upper surface to a block bottom portion.

More specifically, the notches 56 and 56 are respectively provided in the center portions of the first longitudinal side surface portions 32 and 32 of the center blocks 24 and 24 facing each other with the center main groove 18A interposed therebetween. The notches 56 are provided in the center portion in the ridgeline direction of the first longitudinal side surface portion 32, that is, in the vicinity of the center of the ridgeline. The ridgeline is a line generated at an intersection of the side surface and the upper surface (tread surface) of the block. In the center block 24 and the shoulder block 26 facing each other with the shoulder main groove 18B interposed therebetween, also in the center portions of the first longitudinal side surface portion 32 and the third longitudinal side surface portion 42 facing the first longitudinal side surface portion 32, that is, in the vicinity of the center of the ridgeline, the notches 56 and 56 are respectively provided. As described above, it is possible to eliminate a difference in rigidity between the respective blocks 24 and 26 and suppress uneven wear by providing the notches 56 in the center portions of the first longitudinal side surface portion 32 and the third longitudinal side surface portion 42.

As illustrated in FIGS. 2 and 4, a reinforcing projection portion 58 connecting between the notches 56 and 56 is provided between the notches 56 and 56 facing each other with the main groove 18 interposed therebetween. The reinforcing projection portion 58 is a protrusion that crosses the main groove 18 so as to connect the bottom portions of the notches 56 and 56 facing each other, and protrudes from the groove bottom of the main groove 18. A plurality of protrusions 50 are arranged between the front and rear reinforcing projection portions 58 and 58. In the embodiment, in a case where the plurality of protrusions 50 are disposed at intervals in the groove length direction, other elements such as reinforcing projection portions may be provided between the protrusions 50 as described above. Moreover, the height of the reinforcing projection portion 58 is set to be equal to the height of the protrusion 50.

In FIGS. 2 to 4, reference numeral 60 is a cut, that is, a sipe provided in each of the blocks 24 and 26 in order to improve the traction property, and a plurality of sipes are provided in each of the blocks 24 and 26. Reference numeral 62 is a bridge portion connecting between the front and rear center blocks 24 and 24, and between the front and rear shoulder blocks 26 and 26, respectively, and is provided in a raised shape at the groove bottom of each of the lateral grooves 20.

According to the embodiment having the above structure, the connecting portion 54 is provided to the protrusion 50 provided at the groove bottom of the main groove 18 and is connected to the longitudinal side surface portion 28, 36 of the land portion facing each other, and whereby the protrusion 50 is reinforced. Therefore, chipping of the protrusion 50 due to impact of the stone can be suppressed. Further, the traction property at the final stage of wear can be improved by the connecting portion 54. Moreover, a flow of rubber during tire vulcanization is improved and the failure of rubber flow is suppressed. Therefore, it is possible to improve the formability of the protrusions 50.

Further, it is possible to suppress a decrease in the drainability of the main groove 18, to improve the wet property, and to suppress chipping of the connecting portion 54 itself by setting the height H2 of the connecting portion 54 equal to or less than the height H1 of the protrusion 50. The height H2 of the connecting portion 54 is preferably 70 to 100% of the height H1 of the protrusion 50. When it is 70% or more, the reinforcing effect of the protrusion 50 by the connecting portion 54 is enhanced, and the chipping suppression effect of the protrusion 50 can be enhanced.

In addition, the connecting portion 54 is easily moved in accordance with the movement of the blocks 24 and 26 during rolling of the tire, and the earth discharging property can be improved by setting the width J2 of the connecting portion 54 to be narrower than the width J1 of the protrusion 50. That is, if the connecting portion 54 connected to the blocks 24 and 26 is thin in thickness, the connecting portion 54 tends to vibrate in conjunction with the movement of the blocks 24 and 26. Therefore, soil (mud) entering into the main groove 18 is easily discharged and it is possible to improve the earth discharging property. The width J2 of the connecting portion 54 is preferably 20 to 60%, more preferably 30 to 50% of the width J1 of the protrusion 50. When it is 20% or more, the reinforcing effect by the connecting portion 54 can be enhanced. In addition, when it is 60% or less, it is possible to enhance the effect of improving the earth discharging property, to suppress the deterioration of the wet property, and to suppress a factor of tire exchange due to a solid feeling.

According to the embodiment, the connecting portion 54 is provided in the range K1 excluding 5% at both ends in the longitudinal direction length K0 of the protrusion 50 in the side surface portion 52 of the protrusion 50. Therefore, it is possible to improve the effect of improving the earth discharging property. In other words, as the connecting portion 54 is connected at a position close to the center of the side surface portion 52 of the protrusion 50, the soil on both sides of the connecting portion 54 can be easily moved and easily discharged by vibration, and the earth discharging property can be improved.

In addition, the connecting portion 54 is provided so as to connect to the right and left blocks 24 and 26 of the main groove 18 alternately to the right and left in the groove length direction, that is, to connect to different blocks 24 and 26 between the adjacent protrusions 50 and 50. Therefore, at the time of rolling the tire, it is possible to shift the timing of the vibration of the connecting portion 54 in the adjacent protrusions 50 and 50, and to improve the earth discharging property.

Further, in the above embodiment, all the protrusions 50 are connected to the adjacent land portions 24 and 26 by the connecting portions 54, but the connecting portions 54 may not necessarily be provided on all the protrusions 50. Further, it may be not to provide the protrusions 50 in all the main grooves 18. Further, the tread pattern is not limited to those in the above embodiment. For example, in the above embodiment, the number of the main grooves 18 is three, but the number of the main grooves is not particularly limited, and may be, for example, four or five. The number of the main grooves 18 is preferably three or four. Although the main groove 18 is a zigzag groove, it may be a straight groove or a tread pattern combining the zigzag groove and the straight groove. Furthermore, the invention is not limited to the one having the block row 22, and in a pattern having the rib-like land portions continuous in the tire circumferential direction, the protrusions may be connected to the rib-like land portions via the connecting portion.

The pneumatic tire according to the embodiment includes various vehicle tires such as a tire for a passenger car, a heavy duty tire of a truck, a bus, or a light truck (for example, an SUV vehicle or a pickup truck) or the like. In addition, applications such as a summer tire, a winter tire, and all-season tire are not particularly limited. It is preferable that the tire is the heavy duty tire.

Each dimension described above in the present specification is provided in a regular state with no load in which the pneumatic tire is mounted on a regular rim and is filled with air of a regular internal pressure. The regular rim is a “standard rim” in the JATMA standard, a “Design Rim” in the TRA standard, or a “Measuring Rim” in the ETRTO standard. The “regular internal pressure” is the “maximum air pressure” in the JATMA standard, the “maximum value” described in “TIRE LOAD LIMITS AT VARIOUS COLD INFLATION PRESSURES” in the TRA standard, or “INFLATION PRESSURE” in the ETRTO standard.

### Examples

In order to confirm the above effects, each heavy duty pneumatic tire (tire size: 11R22.5) of Examples 1 to 3, and Comparative Examples 1 to 3 was mounted on a rim of 22.5×7.50, filled with air of an internal pressure of 700 kPa, mounted on a vehicle with a constant loading capacity of 10 t, and evaluated for a crack resistance property, the traction property at the end of wear, the wet property, and the earth discharging property.

The tire of Example 3 includes features of the embodiment illustrated in FIGS. 1 to 7. In Example 3, the groove width of the main groove 18=11.5 mm, the depth of the main groove 18 H0=16.5 mm, the width of the protrusion 50 J1=3.0 mm, the height of the protrusion 50 H1=4.0 mm, the width of the connecting portion 54 J2=1.0 mm, the height of the connecting portion 54 H2=4.0 mm, and the connecting portion 54 was set at the center of the length K0 in the length direction of the protrusion 50. In addition, the connecting portions 54 were disposed to connect the right and left blocks 24 and 26 of the main groove 18 alternately to right and left in the groove length direction (indicated as “zigzag shape” in Table 1). In the tire of Example 1, the connecting portions 54 are disposed so as to connect to the same side in the groove length direction with respect to the right and left blocks 24 and 26 of the main groove 18 (indicated as “uniform” in Table 1), and others have the same configuration as that of the tire of Example 3. The tire of Example 2 has the same configuration as that of the tire of Example 1 except that the width J2 of the connecting portion 54 is 1.5 mm. The tire of Comparative Example 1 does not have a connecting portion and the others have the same configuration as that of Example 3. In the tire of Comparative Example 2, the height H2 of the connecting portion 54 is 6.0 mm and the others have the same configuration as that of Example 1. In the tire of Comparative Example 3, the width J2 of the connecting portion is 3.0 mm and the others have the same configuration as that of Example 1.

Each evaluation method is as follows.
Crack resistance property: the number of cracks (chipping) in the main groove bottom protrusions and connecting portions after traveling 20,000 km was measured and an inverse number thereof was indexed with the value of Comparative Example 1 taking as 100. The larger the index, the less cracks and the better the crack resistance property.
The traction property at the end of wear: at a time when the tread rubber has a wear rate of 75%, an arrival time when advanced 20 m from a stop state on a road surface having a water depth of 1.0 mm was measured, and an inverse number of the arrival time was indexed with the value of Comparative Example 1 taking as 100. The larger the index, the shorter the arrival time and the better the traction property.
Wet property (wet braking): a tread entered a road surface having a water depth of 1.0 mm at a speed of 40 km/h, the braking distance at the time of sudden braking was measured, and an inverse number of the braking distance was indexed with the value of Comparative Example 1 taken as 100. The larger the index, the shorter the braking distance and the better the wet property.
The earth discharging property (mud property): an arrival time when advanced 20 m from a stop state on a muddy road was measured, and an inverse number of the arrival time was indexed with the value of Comparative Example 1 taking as 100. The larger the index, the shorter the arrival time and the better the earth discharging property.

TABLE 1

| | Comparative | Comparative | Comparative | | | |
|---|---|---|---|---|---|---|
| | example 1 | example 2 | example 3 | Example 1 | Example 2 | Example 3 |
| Presence or | absence | presence | presence | presence | presence | presence |
| absence of the | | | | | | |
| connecting portion | | | | | | |
| Width J2 of | — | 1.0 mm | 3.0 mm | 1.0 mm | 1.5 mm | 1.0 mm |
| connecting portion | | | | | | |
| Height H2 of | — | 6.0 mm | 4.0 mm | 4.0 mm | 4.0 mm | 4.0 mm |
| connecting portion | | | | | | |
| Disposition of | — | uniform | uniform | uniform | uniform | zigzag |
| connecting portion | | | | | | shape |
| Crack resistance | 100 | 102 | 109 | 105 | 107 | 105 |
| property | | | | | | |
| Traction property | 100 | 102 | 105 | 102 | 104 | 107 |
| at end of wear | | | | | | |
| Wet property | 100 | 94 | 92 | 100 | 100 | 100 |
| Earth discharging | 100 | 104 | 97 | 104 | 103 | 107 |
| property | | | | | | |

The results are as shown in Table 1, whereas in Comparative Example 2, although the crack resistance property and the traction property at the end of wear were improved with the provision of the connecting portion, compared with Comparative Example 1 without the connecting portion, the height of the connecting portion was tall, and the wet property was inferior. In Comparative Example 3, although the crack resistance property and the traction property at the end of wear were improved, the width of the connecting portion was large, and the wet property and the earth discharging property were inferior. On the contrary, in Examples 1 to 3, it was possible to improve the crack resistance property and the traction property at the end of wear, and it was possible to improve the earth discharging property without impairing the wet property. In addition, in Example 1, although the crack resistance property and the traction property at the end of wear slightly decreased by reducing the width of the connecting portion compared with the Example 2, the wet property and the earth discharging property were improved. Further, in Example 3, by further disposing the connecting portions in a zigzag shape, a further improvement effect on the traction property at the end of wear and the earth discharging property were obtained compared with Example 1.

While several embodiments are described above, these embodiments are presented by way of example and are not intended to limit the scope of the invention. These novel embodiments can be implemented in various other forms, and various omissions, substitutions, and changes can be made without departing from the spirit of the invention.

What is claimed is:

1. A pneumatic tire comprising:
a tread portion including a main groove extending in a tire circumferential direction; and a land portion partitioned by the main groove,
wherein a plurality of protrusions are disposed at a groove bottom of the main groove at intervals in a groove length direction, and a side surface portion of at least one protrusions is connected to a side surface portion of the land portion via a connecting portion having a height equal to or less than a height of the protrusion and a width narrower than a width of the protrusion.

2. The pneumatic tire according to claim 1, comprising:
blocks which are formed by a plurality of main grooves extending in the tire circumferential direction and a plurality of lateral grooves extending in a direction intersecting the main grooves,
wherein the side surface portion of the protrusion and a side surface portion of the block facing the side surface portion of the protrusion are connected via the connecting portion.

3. The pneumatic tire according to claim 1,
wherein the connecting portions are provided alternately on right and left in the groove length direction with respect to the side surface portions of the land portions on both sides of the main groove.

4. The pneumatic tire according to claim 1,
wherein the connecting portion is provided within a range excluding 5% of a length at both ends of the protrusion in a longitudinal direction at the side surface portion of the protrusion.

5. The pneumatic tire according to claim 1,
wherein the width of the connecting portion is 20 to 60% of the width of the protrusion.

6. The pneumatic tire according to claim 1,
wherein the height of the connecting portion is 70 to 100% of the height of the protrusion.
